(19) United States
(12) Patent Application Publication
(10) Pub. No.: US 2019/0035000 A1
(43) Pub. Date: Jan. 31, 2019

(54) SOCIAL NETWORK SYSTEM AND METHOD

(71) Applicant: Ehsan Soltanipour, Plano, TX (US)

(72) Inventor: Ehsan Soltanipour, Plano, TX (US)

(21) Appl. No.: 16/046,674

(22) Filed: Jul. 26, 2018

Related U.S. Application Data
(60) Provisional application No. 62/538,495, filed on Jul. 28, 2017.

(51) Int. Cl. G06Q 30/06; G06Q 50/00; G06Q 30/02; H04L 12/58

(52) U.S. Cl. CPC G06Q 30/0633; H04L 51/32; G06Q 30/0277; G06Q 50/01

(57) ABSTRACT

The present invention discloses a social network system and method for managing social activities of a user. The system comprises a social network server with an artificial intelligence. The system is configured to integrate e-commerce with re-defined social networking concept for managing social activities of a user and to organize and improves user's virtual life. Advantageously the present invention further configured to enables the user to focus on the gift and fashion market, organize and manage a user's social activities, provides entertaining features, help users to earn money through their activity on the platform, decreases the level of depression, which is a drawback of current platforms, and enables to customize display of advertisements while still permitting their benefits.

### BACKGROUND OF THE INVENTION

### A. Technical Field

The present invention generally relates to a social network system. More specifically, the present invention relates to a social network system and method that integrates e-commerce with re-defined social networking concept for managing social activities of a user.

### B. Description of Related Art

With growing popularity of the Internet, consumers use social network to freely access information and exchange opinions on products and services. User of a website is able to gather information about a product or service of interest based on reviews from previous buyers. Retailers are also able to gather information and feedback on their respective product or service through the Internet. However, ecommerce and social networking websites function independently of each other and consumers have to access different websites to gain information and review feedback before making a purchase. If a user recommends any product or service to his or her friends or family via the social networking websites or shares information regarding it, the retailers on ecommerce websites may not have first-hand access to the recommendations and thoughts posted by the user on the social-networking-site or blog entries. Moreover, user reviews cannot always be trusted due to source/credibility of information, which results in return and exchange of items, wasting money and time in shopping, and confusion caused by different brands and their different sizing scale.

Further, current social media platform has negative roles in people by impacting people social behavior, health and relationship. Further, many people were able to infer many personal traits merely from friend lists, including education level, university attended, hometown and other private data, using simple algorithms and uses the information for cyberbullying. This would lead the social isolation of the individual, and host of mental, psychological, emotional and physical problems including depression, anxiety, somatic complaints and many others. Further, many people, infer personal data of friends to send gifts to making someone feel special and maintain a healthy relationship. However, identifying a desired item of their special one from going through personal information is not possible, which results in sending unnecessary, useless, irrelevant and same gifts.

Therefore, there is a need for a social network system and method that integrates e-commerce with re-defined social networking concept for managing social activities of a user. Further, there is a need for a social network system and method to organize and improves user's virtual life.

### SUMMARY OF THE INVENTION

The present invention discloses a social network system and method for managing one or more social activities. The system integrated e-commerce along with re-defined networking concepts to provide better experience in virtual life of users.

In one embodiment, the present invention comprises a social network system for managing social life activities. In one embodiment, social network system comprising, a social network server with artificial intelligence comprising a processor and a memory unit, a database in communication with the server for storing plurality of user related information and information related to ecommerce platform, and a user device configured to access the server via a network. The memory unit stores a set of program modules, and the processor in communication with the memory unit, configured to execute the set of program modules. In one embodiment, the set of program modules comprises, but not limited to, a registration module, a friend list management module, a body measurement module, a gift module, a profile management module, an entertainment module, a relationship management module, a rating module, an assistance module and a social score module.

In one embodiment, the registration module is configured to allow a user to create a user account by providing user information, wherein the user information comprises data to identify the user account, user private information and user public information. The friend list management module configured to allow the user to group a list of friends in one or more categories, wherein each category comprises a particular level of access to the user information.

In one embodiment, the body measurement module is configured to allow the user to add measurement of body parts of the user, provide a 3D model of the user with 360-degree rotation, and enable the user to convert clothing size based on the brand and country of the retailer.

In one embodiment, the gift module in communication with the body measurement module is configured to allow the user to add one or more items to a gift list, allow the user to access the gift list of other users, allow the user to access the body parts measurement data of other users, allow the user to create a group comprising one or more friends to select one or more gift items to purchase the gift as a group, allow the user to connect with one or more retailer to purchase a desired gift from the gift list, allow the user to send notification to other users about the purchase of the gift, and enable the user to add gift data of received gifts in a received gift list, wherein the gift data includes brief description of the gift, event name, event date and location, and person who gave the gift.

The profile management module is configured to allow the user to create encrypted address to share with other users, allow the user to share a post to one or more category of friends, allow the user to share the post to one or more category of friends with emoticon, allow the user to share the post to one or more category of friends anonymously, allow the user to select preferred type of advertisements, and display advertisements only on selection of advertisement tab. In one embodiment, the profile management module is further configured to: enable the user to freeze the account to preventing user from accessing the account and allow other users to share content or send friend request, enable the user to deactivate the account temporarily preventing other users to access the account, allow the user to delete the account permanently, enable the user to identify location of one or more user in the friend list, enable the user to add event data, enable the user to add data of activity experienced for the first time, wherein the activity data comprises first car, first trip, first overseas travel, enable the user to add an activity related data, wherein the activity data comprises buying an item, hired in a company, configured to enable the user to identify connection between a particular user and other users in the friends list of the user via a chart, and enable the user to send appreciation to one or more user in the friends list.

In one embodiment, the profile management module is further configured to: enable the user to search for users by assigning filters including sex, age, location, favourites, ancestry, education, career, marital status, status, enable the user to view his or her profile as a third-party user, allow the user to delay the time to share content to by setting time delay, enable the user to receive notification, wherein if any of his/her friends have been inactive for more than the chosen period, and allow the user to upload files and move the uploaded file in desired section including gallery, share content. In one embodiment, the entertainment module is configured to enable the user to participate in an event to predict outcome of the event, wherein if the user predicted outcome is correct, a reward point is provided to the user.

In one embodiment, the relationship management module is configured to provide a virtual character with artificial intelligence, allow the user to deliver a message to the other user via the virtual character, and allow the user to check compatibility with the other user. In one embodiment, the rating module is configured to allow the user to rate on one or more criteria of on purchase of the gift and allow a user to provide an overall rating on the purchase of the gift. In one embodiment, the assistance module is configured to allow the user to assist other user in need of assistance and acquire assistance from another user. In one embodiment, the social score module is configured to measure a social power of the user.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a block diagram of an environment implemented, according to one embodiment of the present invention.

FIG. 2 exemplarily illustrates a block diagram of a social network server, according to one embodiment of the present invention.

FIG. 3 exemplarily illustrates a screenshot of login page, according to one embodiment of the present invention.

FIG. 4 exemplarily illustrates a screenshot of a friend request, according to one embodiment of the present invention.

FIG. 5 exemplarily illustrates a screenshot of assigning a category to a friend according to one embodiment of the present invention.

FIG. 6 exemplarily illustrates a screenshot of assigning filter to identify a friend from the friends list, according to one embodiment of the present invention.

FIG. 7 exemplarily illustrates a screenshot of a categorized friends list of the user, according to one embodiment of the present invention.

FIG. 8 exemplarily illustrates a screenshot of a webpage to post content, according to one embodiment of the present invention.

FIG. 9 exemplarily illustrates a screenshot of a webpage to convert user address into an encrypted address, according to one embodiment of the present invention.

FIG. 10 exemplarily illustrates a screenshot of address tab visible to other users in the social network system, according to one embodiment of the present invention.

FIG. 11 exemplarily illustrates a screenshot of managing posts of the user profile, according to one embodiment of the present invention.

FIG. 12A exemplarily illustrates a screenshot of filters used to display preferred post, according to one embodiment of the present invention.

FIG. 12B exemplarily illustrates a screenshot of filter to display post from one or more specified friends, according to one embodiment of the present invention.

FIG. 12C exemplarily illustrates a screenshot of filter to allow the user to share post to a specified category of friends, according to one embodiment of the present invention.

FIG. 12D exemplarily illustrates a screenshot of filters to receive of display post from one or more specified category of friends, according to one embodiment of the present invention.

FIG. 13 exemplarily illustrates a screenshot of customization various functions of the social network system via a single webpage, according to one embodiment of the present invention.

FIG. 14 exemplarily illustrates a screenshot of a webpage to rate a vendor service and products, according to one embodiment of the present invention.

FIG. 15 exemplarily illustrates a screenshot of adding one or more items to the gift list of the user, according to one embodiment of the present invention.

FIG. 16 exemplarily illustrates a screenshot of gift list of the user, according to one embodiment of the present invention.

FIG. 17 exemplarily illustrates a screenshot of filters and sort option to identify a gift to present from a friend's gift list, according to one embodiment of the present invention.

FIG. 18 exemplarily illustrates a screenshot of creating a group to purchase a group gift, according to one embodiment of the present invention.

FIG. 19 exemplarily illustrates a screenshot of request received to join group gifting process, according to one embodiment of the present invention.

FIG. 20 exemplarily illustrates a screenshot of a webpage to customize the advertisement displayed in the user profile, according to one embodiment of the present invention.

FIG. 21 exemplarily illustrates a screenshot of a webpage to identify compatibility of the user with other user to initiate conversation, according to one embodiment of the present invention.

FIG. 22 exemplarily illustrates a screenshot of calculation of percentage of chance to start a relationship with a user, according to one embodiment of the present invention.

FIG. 23 exemplarily illustrates a screenshot of customization of message to be delivered, according to one embodiment of the present invention.

FIG. 24 exemplarily illustrates a screenshot of posting activity data such as a story of vacation, according to one embodiment of the present invention.

FIG. 25 exemplarily illustrates a screenshot of shared activity data, according to one embodiment of the present invention.

FIG. 26 exemplarily illustrates a screenshot of uploading data of a desired gift to the gift list, according to one embodiment of the present invention.

FIG. 27 exemplarily illustrates a screenshot of shared gift data to other users, according to one embodiment of the present invention.

FIG. 28 exemplarily illustrates a screenshot of customization of access to user information for one or more specified group of friends, according to one embodiment of the present invention.

FIG. 29A-29D exemplarily illustrates a screenshot of uploading files into the user account and posting the uploaded files in the desired location such as gift list, gallery, according to one embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

The present invention discloses a social network system and method for managing one or more social activities. The system integrated e-commerce along with re-defined networking concepts to provide better experience in virtual life of users.

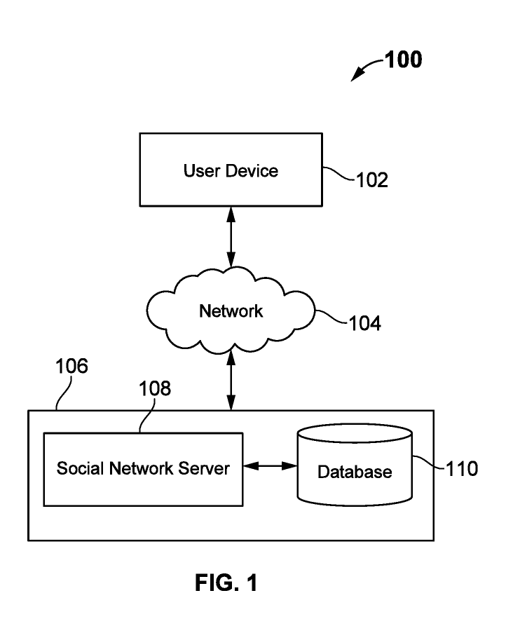

Referring to FIG. 1, a block diagram of an environment 100 implemented in accordance with various embodiments of the present invention is disclosed. The environment 100 comprises a user device 102, a network 104, and social network system 106. In an embodiment, the social network system 106 comprises a social network server 108 and at least one database 110.

In an embodiment, the user device 102 is enabled to access the social network system 106 via the network 104 for managing one or more social activities. The social network server 106 is configured to integrated e-commerce along with re-defined networking concepts to provide better experience in virtual life of users. In an embodiment, the user device 102 is at least one of a desktop, a laptop, a tablet, a mobile phone, and mobile and/or handheld electronic devices. In an embodiment, the user device 102 is in communication with the network 104 to access the social network server 108. In an embodiment, the network 104 could be Wi-Fi network, WiMAX network, and wireless local area network.

In one embodiment, the at least one database 110 may be accessible by the social network server 108. The database 110 may be integrated into the social network server 108 or separate from it. In some embodiments, the database 110 resides in a connected server or in a cloud computing service. Regardless of location, the database 110 comprise a memory to store and organize certain data for use by the social network server 108. In some embodiments, the database stores plurality of user related information, information related to ecommerce platform. The user related information includes first and last name, public name, profile picture, body measurements, date of birth, gender, ancestry information, address, education, career, phone number, e-mail address, birthday, graduation, anniversary, wedding, baby shower, bridal shower, promotion, memorial, awards ceremonies, family/class reunions, engagement, user's favourites, user's favorite people.

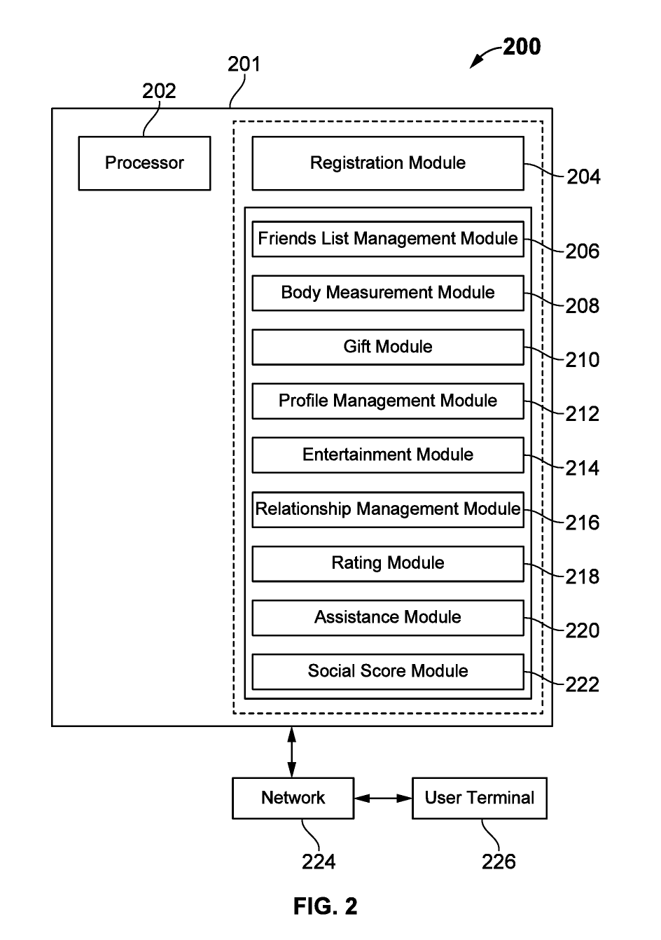

In one embodiment, the social network server 108 is at least one of a general or special purpose computer. The social network server 108 could be operated as a single computer, which can be a hardware and/or software server, a workstation, a desktop, a laptop, a tablet, a mobile phone, a mainframe, a supercomputer, a server farm, and so forth. In some embodiments, the computer could be touchscreen and/or non-touchscreen and adopted to run on any type of OS, such as iOS™, Windows™, Android™, Unix™ Linux™ and/or others. In one embodiment, the plurality of computers is in communication with each other, via networks. Such communication can be via a software application, a mobile app, a browser, an OS, and/or any combination thereof. Further, a block diagram 200 of an exemplary implementation of the social network server 108 is illustrated in FIG. 2.

FIG. 2 is a block diagram 200 of the social network server 108 in an embodiment of the present invention. The social network server 108 comprises a processor 202 and a memory unit 201. The memory unit 201 comprises a set of program modules comprises a registration module 204, a friend list management module 206, a body measurement module 208, a gift module 210, a profile management module 212, an entertainment module 214, a relationship management module 216, a rating module 218, an assistance module 220, a social score module 222 and a network 224. The processor 202 is configured to execute the set of program module. In one embodiment, the user could access the modules of the memory unit 201 via a user terminal 226. In one embodiment, the user terminal 226 could be, but not limited to, at least one of a desktop, a laptop, a tablet, a mobile phone, and mobile and/or handheld electronic devices.

The Registration module 204 configured to enable a a user to create a user account by providing user information, wherein the user information comprises data to identify the user account, user private information and user public information. In an embodiment, the user account or profile comprises user information, personal events, events, user's favourites, User's Favorite People. In one embodiment, the user information includes, but not limited to, first and last name, public name, profile picture, body measurements, date of birth, gender, ancestry information, address, education, career, phone number, e-mail address, etc. In one embodiment, the personal events include, but not limited to, birthday, graduation, anniversary, wedding, baby shower, bridal shower, promotion, memorial, awards ceremonies, family/class reunions, engagement, etc. In one embodiment, the events include personal and local events and holidays by name and date, which comprises one or more filters to manage and display events and holidays in other countries. In one embodiment, the user's favourites includes stores, brands, colours, vacation spots, favourite political party, restaurants, cities, countries, sports teams, etc. In one embodiment, the user's favorite people includes celebrities, scientist, athletes, actors/actresses, singers, artists, writers, politician, etc.

In one embodiment, the user account is a default regular account. In another embodiment, the registration module 204 enables the user to create shadow account on behalf of behalf of seniors, disabled, babies, infants, toddlers and those who don't have knowledge to use computer/smart phone, etc. The shadow account also comprises user information to provide information of the user managing the account.

In an example, parents could create a shadow account for their children months before birthdate, and add additional information needed for the baby shower registrar until that child gets older and the user could manage the account.

In an embodiment, the user account comprises one or more modes to provide access to features of various levels. One or more modes includes kid's mode, simple mode, regular mode, full mode and premium mode. The kid's mode is configured to use by children, which includes simple safe tools, features along with kid's theme and an algorithm to filters inappropriate words and harmful materials. The simple mode is configured to use by people little knowledge in computers/smartphones and advanced apps/websites. The simple mode includes the least necessary tools and features that are simple and easy to learn and use. The regular mode includes few advanced features. The full mode or professional more includes advanced features and tools. The premium mode comprises all advanced features and tools of the social network system 106.

The friend list management module 206 is configured to allow the user to group a list of friends in one or more categories, wherein each category comprises a particular level of access to the user information. In one embodiment, the one or more categories includes hot, warm, chilly, cold, and ice. In one embodiment, the hot category includes couples, boyfriend, girlfriend, sex partners, very close friends. In one embodiment, the warm category includes family members, relatives, close friends, etc. In one embodiment, the chilly category includes colleagues, teammates, regular friends, etc. In one embodiment, the cold category includes friends who cannot be added to any other categories. In one embodiment, the ice category includes for public access and people who user cannot or don't like to accept/reject/ignore their friend's request. Further, grouping of friends could not be seen by other users in the friend list for privacy purposes.

The body measurement module 208 is configured to allow the user to add measurement of body parts of the user. The body measurement module 208 is further configured to display a guide to measure body parts by a tape measure or using a string and a ruler. Then, the user need to enter data into a table, which requests body part sizes including head, neck, chest/bust, center back, back waist length, armhole depth, cross back, waist, hip, arm length, sleeve length, wrist, etc. Further, the body measurement module 208 is configured to allows the user to switch between different country's size charts and find the right size on different brands in different countries. For example, size “M” in brand “ABC” may be size L in brand “XYZ”. This issue is overcome by the present invention by enabling the user to convert clothing size charts based on the brand and country of the retailer.

The body measurement module 208 is further configured to provide a 3D model of the user with 360-degree rotation. A 3D concept of the user's body is created based on the measurements provided in physical characteristics & size table. The garment sizes will be more accurate by using a 3D model of the body with 360-degree rotation. Then, the user is enabled to apply clothing on the 3D model from another brand to check how the user would look in that particular garment and also enables the user to select more accurate garment.

The gift module 210 is configured to allow the user add one or more items to a gift list. The gift module 210 is further configured to allow the user to access the gift list of other users. The gift module 210 in communication with the body measurement module 208 is further configured to allow the user to access the body parts measurement data of other users. The gift module 210 is further configured to allow the user to create a group comprising one or more friends to select one or more items. The gift module 210 is further configured to allow the user to connect with one or more retailer to purchase a desired gift from the gift list. The gift module 210 is further configured to allow the user to send notification to other users about the purchase of the gift. The gift module 210 is further configured to configured to enable the user to add gift data of one or more gift received, wherein the gift data includes brief description of the gift, event name, event date and location, and person who gave the gift.

In one embodiment, the functions of the gift module 210 are detailly explained as follows. The system is configured to enable the user to add an Item or a product from listed categories and subcategories and describe a gift with more specific detail like the brand, price range, manufacturer, style, etc. The user is also enabled to add anything from online stores. further, to identify a gift for a friend in the friend list, the user is enabled to access the list of gifts in the friend's profile. Once the user finds a desired item to gift, the user to click on the item or product of the friend's profile, to automatically removes the item from the gift list. Further, a notification would be sent about the picked gift to all gift recipients' friends, blocking the gift buyer information. This helps to prevent a person from receiving the same gift from multiple people.

In another embodiment, after a user finds a gift for a friend's favorite gift list, the user need to click on a link to transfer the user to a page that displays online stores that sell the product. Then, the user could compare the prices and decide which store to select. After the user has checked out and paid for the product, two shipping options is provided to the user. The first option requires the user to enter the user's address to receives the gift. By doing so, the user could present the gift directly to the recipient. The second option is to send the gift to the receipt's address. For privacy and security reasons, if the user is not in the hot or warm friends group, the gift receipt's address would not be visible to the user. But the user would receive a confirmation containing a receipt and estimated date of shipping and delivery at the end. In yet another embodiment, the user is enabled to send anonymously.

In yet another embodiment, the gift module 210 is configured to enable the user to create a virtual group and buy gift(s) for a friend or a family member. For example, if in a family, children want to buy a gift for their mom, the person-in-charge creates the group and adds other siblings and also the gift which will be purchased along with everyone's share. Users who are in this group is configured to receive a notification about it, and they have the option to put money and participate or decline. Additionally, the user, who is in charge of the group provided with an option to allow the group members' name to be shown or not shown to other members. This is because if someone couldn't pay for the gift, feel free not to participate and the only one who will notify is the person who has created the group. It eliminates any pressure on group members who cannot afford the money for any reason.

The profile management module 212 is configured to allow the user to create encrypted address to share with other users. The system allows the user to their complete address and converts it into the encrypted address. The encrypted address includes a 9-digit/letter code, which would be displayed in the user profile. A user who shares his encrypted address could receive gifts from friends at home address without being worry about his privacy. If the user's friend wants to send a gift to him, the encrypted address is need to be pasted into the shipping address, the system would retrieve the full address, and the item would be sent to the recipient.

The profile management module 212 is configured to allow the user to share a post to one or more category of friends. The profile management module 212 is configured to allows the user to share the post to one or more category of friends with emoticon, such as, fear (feeling afraid), anger (feeling angry), sadness (feeling sad) joy (feeling happy), disgust (feeling something is wrong or nasty), surprise (being unprepared for something) or neutral (no emotion). The profile management module 212 is configured to allows the user to share the post to one or more category of friends anonymously.

The profile management module 212 is configured to allows the user to select preferred type of advertisements and display the advertisements only on the advertisement tab. This allows the user to check on advisements only when they decide to buy any item or service. The user is enabled to filter advertisement by using filters such as item, category, liked ads, rates by other users, price/date range, views, deals, recommended, etc.

The profile management module 212 is further configured to enables the user to freeze the account to preventing user from accessing the account and allows other users to share content or send friend request. The profile management module 212 is further configured to enables the user to deactivate the account temporarily preventing other users to access the account or from receiving shared contents or friend request. The profile management module 212 is further configured to allows the user to delete the account permanently. In one embodiment, the system allows to restore the permanently deleted account. On selection of permanent deletion of account, the system allows the user save a backup of all information in the user account in a user device. In one embodiment, if the user prefers to reopen the deleted account, the user could upload the backup data into the system and need to provide credentials identifying the user such as username and password, thereby enabling the user to activate the deleted account.

The profile management module 212 is further configured to enable the user to identify location of one or more user in the friend list. This function of the system is useful, for example, when the user attends a party and want to know if there is anybody at that event whom the user knows, or it can be used in any other locations to find who is there from the list of user's friends.

The profile management module 212 is further configured to enable the user to add event data, configured to enable the user to add data of activity experienced for the first time, wherein the activity data comprises first car, first trip, first overseas travel. The profile management module 212 is further configured to enable the user to add an activity related data, wherein the activity data comprises buying an item, hired in a company, graduation event, best birthday gift, best high school friend, best boss, best jean brand, best music, best movie, best actor/actress, best trip, best teacher, best car.

The profile management module 212 is further configured to enable the user to identify connection between a particular user and other users in the friends list of the user via a chart. The function enables the user to check if a person is a friend of our friends or if that person has any connection to more than one of the user's friends. The profile management module 212 is further configured to enable the user to send appreciation to one or more user in the friends list, wherein the appreciation could be a gift or a thank you note.

The profile management module 212 is further configured to enable the user to search for other users by assigning filters including sex, age, location, favourites, ancestry, education, career, marital status, status. For instance; if a user is looking for people in the user's city which have the same or close ancestry, the user will see the matched people, but the information will be visible to the user only if shared to the public. The profile management module 212 is further configured to enable the user to view his or her profile as a third-party user. The present invention further enables the user to find their match based on items, such as common personality traits, ancestry, ethnicity, social behavior, etc.

The profile management module 212 is further configured to allows the user to delay the time to share content to by setting time delay. In an example, sometimes right after clicking on create/submit/publish/send, the user realizes that he/she made a mistake. By using this feature, the user could enable a certain second's delay after publishing contents, which helps the user to delete or modify the post before sent to other users. The profile management module 212 is further configured to notify the user, if any of his/her friends have been inactive for more than the chosen period. The profile management module 212 is further configured to allow the user to upload files and move the uploaded file in desired section including gallery, share content.

The profile management module 212 is further configured to provide a quick, simple and clear understanding of what has changed since the user's last login. By logging into the account, the system provides a blinking number or a flashing background color at the corner of each function on the home screen to indicate changes.

The entertainment module 214 is configured to enable the user to participate in an event to predict outcome of the game, wherein if the user predicted outcome is correct, a reward point is provided to the user. The entertainment module 214 is further configured to provide a lottery system for users and the winners would receive rewards such as user's favorite celebrity's autograph.

The entertainment module 214 is further configured to allows the user to load international calendars and add events to the calendar. For example, if a user lives in the United States and his girlfriend is Japanese, he can add Japan to his events line, and, therefore, he will not miss any important Japanese events.

The relationship management module 216 is configured to provide a virtual character with artificial intelligence, allows the user to deliver a message to the other user via the virtual character. In one embodiment, the message comprises background sound, voice effects, emotions, facial expressions, mood, add items, body language. In one embodiment, a music or sound file could be selected to play at background. In one embodiment, the voice effects include male, female, old, young or kid voices. In on embodiment, the emotions include joy, surprise, neutral, excited, sad, anger or fear. In one embodiment, the facial expressions/mood includes happiness, sadness, anger, fear, confusion, shame, surprise, focus, exhaustion, seduction, etc. In one embodiment, the items include flower, ring, heart, letter, gift box, envelope etc. In one embodiment, the body language function allows the user to adjust the body language of the virtual character such as body movements and gesture, blink, behavior, and conditions like respect, love, propose, request or even anger.

The relationship management module 216 is further configured to allows the user to check compatibility with the other user. The system is configured to check all of the user's friends and friends of friends to see who is compatible with the user based on the user's situation, circumstances, personality, age, location, sex, education, career, ancestry, etc. Then, it makes a list of potential people. The system enables the user to add at least one potential person. Then, the system starts to analyze the profile of that person to check for the person's sex, age, education, career, physical characteristics, place of birth, place of live, marital status, family status, relationship and other basic information. After analyzing the information mentioned above, the user would receive a percentage number, which shows the chance percentage that the user has to start a relationship with that person. Based on the chance percent, the user may decide to continue the process to check the compatibility percent. The compatibility percent is identified by analyzing ancestry information, favorites, firstee, bestee, ttff, traitmark, ranks, shopping behavior, social behavior, social gauge, languages, giftorite, etc. If the compatibility percent, the system displays option to select or end the process.

If the user chose to continue the process, the system is configured to display a table which displays the user's information that the user may want to share with that person, in the case, if he/she is not in on the user's friend list or even if the user wants to share more information with her/him if that person is already the user's friend. Finally, the system displays a list of questions to start interaction with the other person. The relationship module further provides options to the user to decide one a time to send the message to that person, for example, the option could be to send the message when that person is online.

The rating module 218 configured to allow a user to rate on one or more criteria of on purchase of the gift. In one embodiment, the one or more criteria comprises quality/condition/functionality, design/variety/diversity, price/worthiness, personnel/staff, timeliness, organization/management, service/delivery/shipment, information/clarification, cleanliness and usefulness. The rating module 218 is further configured to allow the user to provide an overall rating on the purchase of the gift or service.

The assistance module 220 configured to allow the user to assist other user in need of assistance and acquire assistance from another user. In one embodiment, the assistance module 220 provides a procedure to allow users to earn money. The users who are familiar with all aspects of system, with at least one year of active history in system platform can take up a test to get professional user certificate (PUC). on passing the test, the certificate would be displayed on their account and will be visible for everybody. Then they can assist other users who will direct from the customer service platform to any of available PUs. By taking care of each user, the user is configured to gain points.

In another embodiment, the assistance module 220 is further configured to enable the user to describe the decision that he/she wants to make and share that with his/her friends to see their opinions/comments. The decisions could be for buying a house, selecting an academic major or future occupation to buy a gift. In yet another embodiment, the assistance module 220 is further configured to offer the user various services, that allow the user to find the proper clothing and can pay a small monthly fee to have the recommendation and suggestions from fashion experts. Fashion expert (s) of the present invention will analyze a user's information such as physical characteristics, lifestyle age, sex, education, profession, budget and also favorite style gallery to find out her/his favorite styles. This way the fashion expert can help the user in the best and most accurate way.

The social score module 222 is configured to measure a social power of the user. The social power of the user is calculated based on number of contents shared by the user, number of messages sent by the user, number of messages received by the user, events made by the user, events participated by the user, gift provided by the user, gift received by the user, and category of the user on the friends list of another user.

In one embodiment, the present invention provides a method for managing social activities and virtual life. The method is incorporated in the system comprising a server with a processor and a memory unit, a database in communication with the server for storing plurality of user related information and information related to ecommerce platform, and a user device configured to access the server via a network. At one step, the method includes, allowing at the processor, via a registration module, a user to create a user account by providing user information, wherein the user information comprises data to identify the user account, user private information and user public information. At another step, the method includes, allowing at the processor, via a friend list management module, the user to group a list of friends in one or more categories, wherein each category comprises a particular level of access to the user information. At another step, the method includes, allowing at the processor, via a body measurement module, the user to add measurement of body parts of the user, to provide a 3D model of the user with 360-degree rotation, and enable the user to convert clothing size based on the brand and country of the retailer. At another step, the method includes, allowing at the processor, via a gift module in communication with the body measurement module, the user to add one or more items to a gift list, allow the user to access the gift list of other users, the user to access the body parts measurement data of other users, the user to create a group comprising one or more friends to select one or more gift items to purchase the gift as a group, the user to connect with one or more retailer to purchase a desired gift from the gift list, the user to send notification to other users about the purchase of the gift, and the user to add gift data of received gifts in a received gift list, wherein the gift data includes brief description of the gift, event name, event date and location, and person who gave the gift.

At another step, the method includes, allowing at the processor, via a profile management module, the user to create encrypted address to share with other users, the user to share a post to one or more category of friends, the user to share the post to one or more category of friends with emoticon, the user to share the post to one or more category of friends anonymously, and the user to select preferred type of advertisements, and display advertisements only on selection of advertisement tab.

At another step, the method includes, enabling at the processor, via an entertainment module, the user to participate in an event to predict outcome of the event, wherein if the user predicted outcome is correct, a reward point is provided to the user. At another step, the method includes, allowing at the processor, via a relationship management module, to enable a virtual character with artificial intelligence, the user to deliver a message to the other user via the virtual character, and the user to check compatibility with the other user. At another step, the method includes, allowing at the processor, via a rating module configured, the user to rate on one or more criteria of on purchase of the gift and allow a user to provide an overall rating on the purchase of the gift. At another step, the method includes, allowing at the processor, via an assistance module, the user to assist other user in need of assistance, and acquire assistance from another user. At another step, the method includes, measuring at the processor, via social score module, a social power of the user.

At another step, the method includes, allowing at the processor, via the profile management module, the user to freeze the account to preventing user from accessing the account and allow other the user to share content or send friend request, the user to deactivate the account temporarily preventing other users to access the account, the user to delete the account permanently, the user to identify location of one or more user in the friend list, the user to add event data, the user to add data of activity experienced for the first time, wherein the activity data comprises first car, first trip, first overseas travel, the user to add an activity related data, wherein the activity data comprises buying an item, hired in a company, configured to enable the user to identify connection between a particular user and other users in the friends list of the user via a chart, and the user to send appreciation to one or more user in the friends list.

At another step, the method includes, allowing at the processor, via the profile management module, the user to search for users by assigning filters including sex, age, location, favourites, ancestry, education, career, marital status, status, the user to view his or her profile as a third-party user, the user to delay the time to share content to by setting time delay, the user to receive notification, wherein if any of his/her friends have been inactive for more than the chosen period, and the user to upload files and move the uploaded file in desired section including gallery, share content.

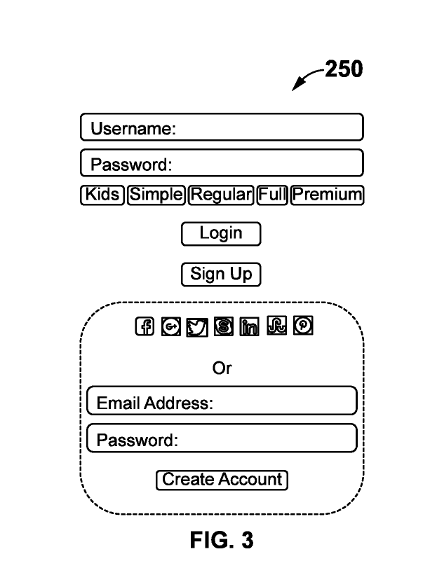

FIG. 3 exemplarily illustrates a screenshot 250 of login page, according to one embodiment of the present invention. In one embodiment, the login page comprises a signup module and a login module. In one embodiment, the user could enter the credentials of information such as username and password in the login module. In one embodiment, the user could sign up by entering the credentials or information such as E-mail and password via the signup module. In one embodiment, the user could also login via some other applications such as, but not limited to, Facebook, twitter, google, skype, linked in, etc. In one embodiment, the login page comprises different login modes such as kids, simple, regular, full and premium modes. If once the user login is successful, then the system identifies the user's type of account and displays information depending on the modes. In an exemplary embodiment, for all regular users, the system could turn on the simple, regular and full modes. For shadow account users, the system could turn on the kids and regular modes, and all other modes would be turned off.

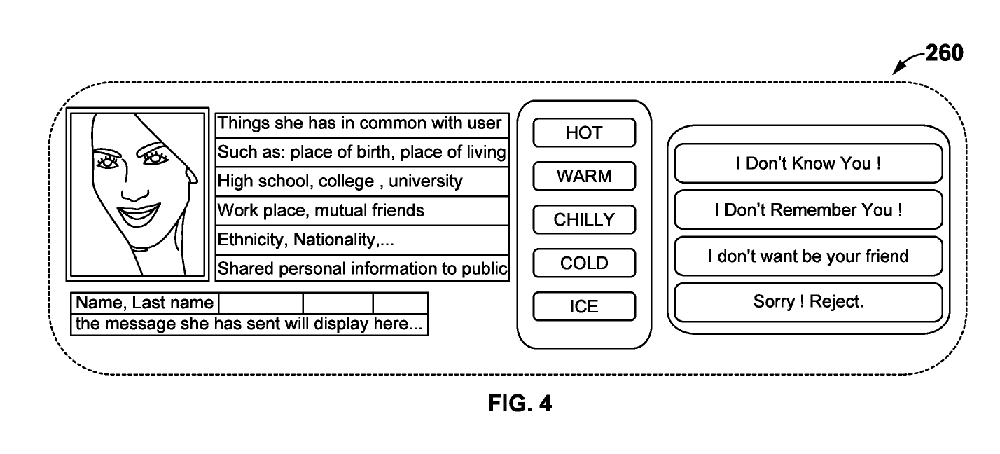

FIG. 4 exemplarily illustrates a screenshot 260 of a friend request, according to one embodiment of the present invention. In one embodiment, the screenshot of a friend request shows the user information such as, but not limited to, profile picture, name, place of birth, place of living, school, college, work place, mutual friends and nationality, etc. In one embodiment, the friend request shows different categories or groups such as hot, warm, chilly, cold and ice for grouping purpose. In one embodiment, the user could choose any one of the categories or groups for the friend. In one embodiment, the system provides options such as, but not limited to, “I Don't know you”, “I Don't remember you”, I don't want to be your friend“, and Sorry! reject” for the user either to accept the friend request or simply reject. In one embodiment, the system could compare the user's profile with the profile who sends the request and display's the common things of the friend's profile to the user.

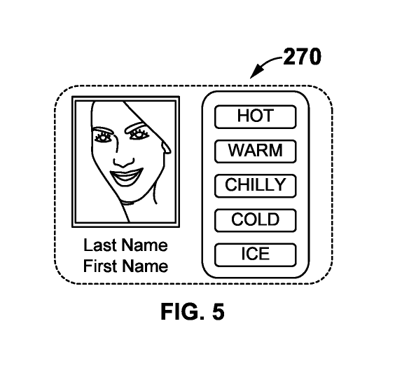

FIG. 5 exemplarily illustrates a screenshot 270 of assigning a category to a friend, according to one embodiment of the present invention. In one embodiment, the system displays different categories or groups such as hot, warm, chilly, cold and ice. In one embodiment, the user could choose any one of the categories or groups for the friend based on the character or profile picture.

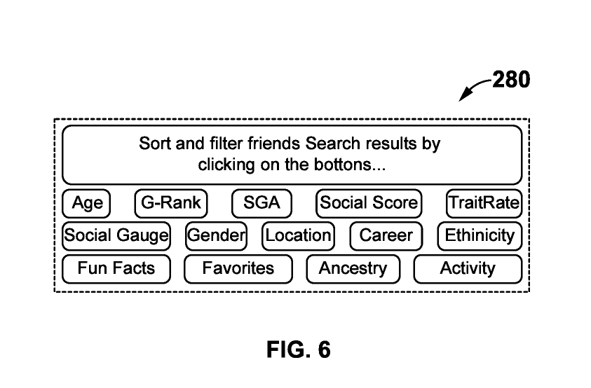

FIG. 6 exemplarily illustrates a screenshot 280 of assigning filter to identify a friend from the friends list, according to one embodiment of the present invention. In one embodiment, the filter comprises age, social score, gender, location, career, ethnicity, fun facts, favourites, ancestry and activity. This enables a user to find friends having common interest.

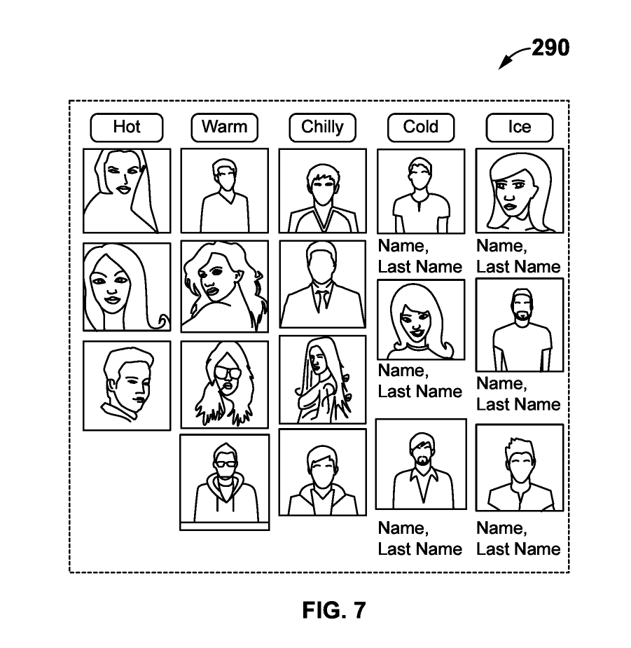

FIG. 7 exemplarily illustrates a screenshot 290 of a categorized friends list of the user, according to one embodiment of the present invention.

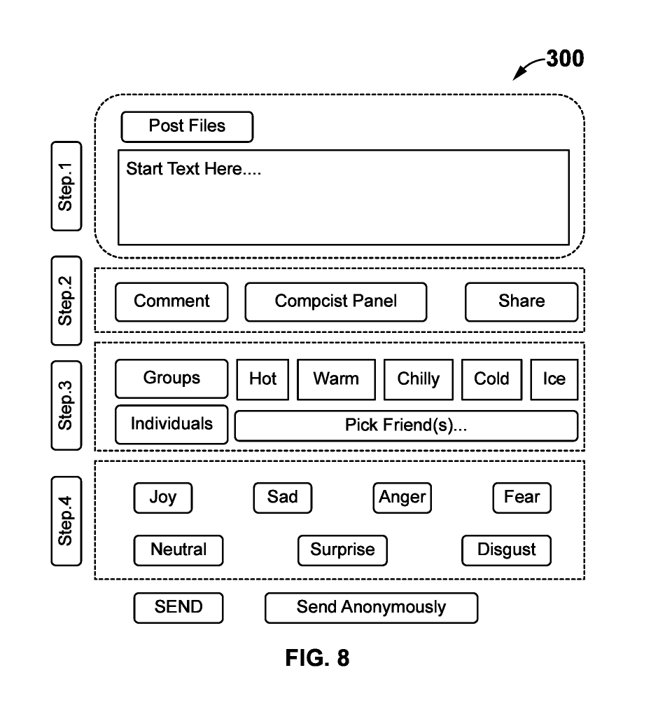

FIG. 8 exemplarily illustrates a screenshot 300 of a webpage to post content, according to one embodiment of the present invention. The system is configured to provide a panel to post a content. If the user hasn't set the default mode in stage manager, the user could select comments, share, and compcist panel to be on or off for each post. Further, the user is enabled to share the content with an individuals or groups of friends. The user need to select at least one emoticon button to send the post. In some embodiments, the user could send the post the content anonymously after agreeing to certain terms and conditions.

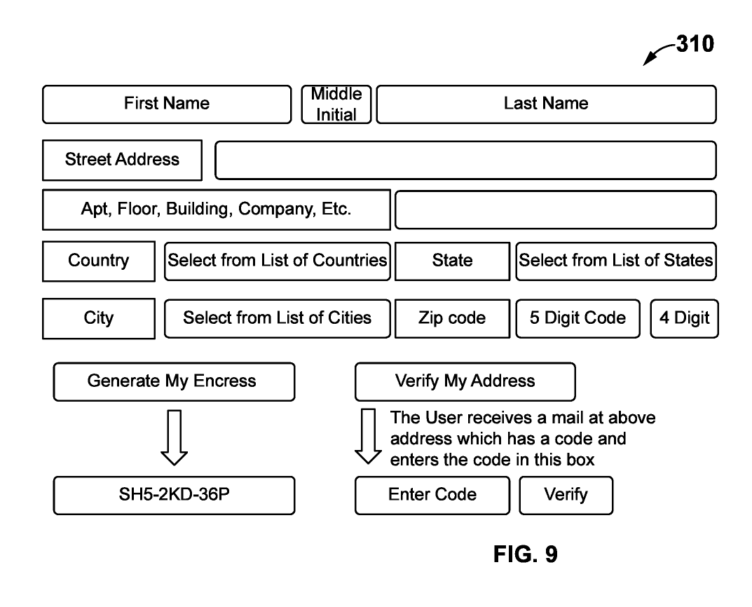

FIG. 9 exemplarily illustrates a screenshot 310 of a webpage to convert user address into an encrypted address, according to one embodiment of the present invention. In an embodiment, the user need to enter full user address such as first name, middle name, last name, street address apt, floor, building, company, country, state, city, zip code. on entering the address, the user need to verify the address by entering a code shared to the user. Further, on verification of address, the address could be converted to an encrypted form using convert option.

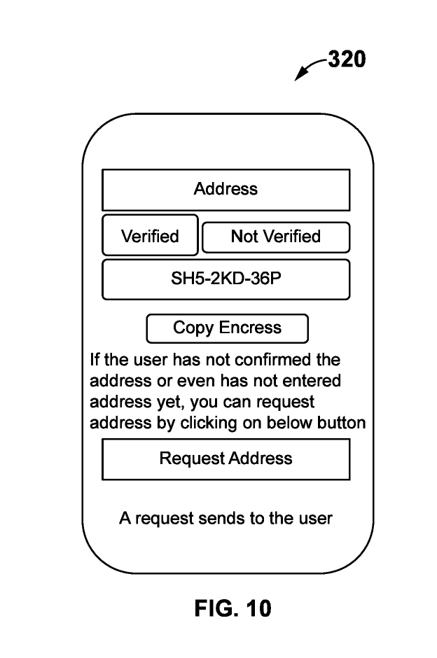

FIG. 10 exemplarily illustrates a screenshot 320 of address tab visible to other users in the social network system, according to one embodiment of the present invention.

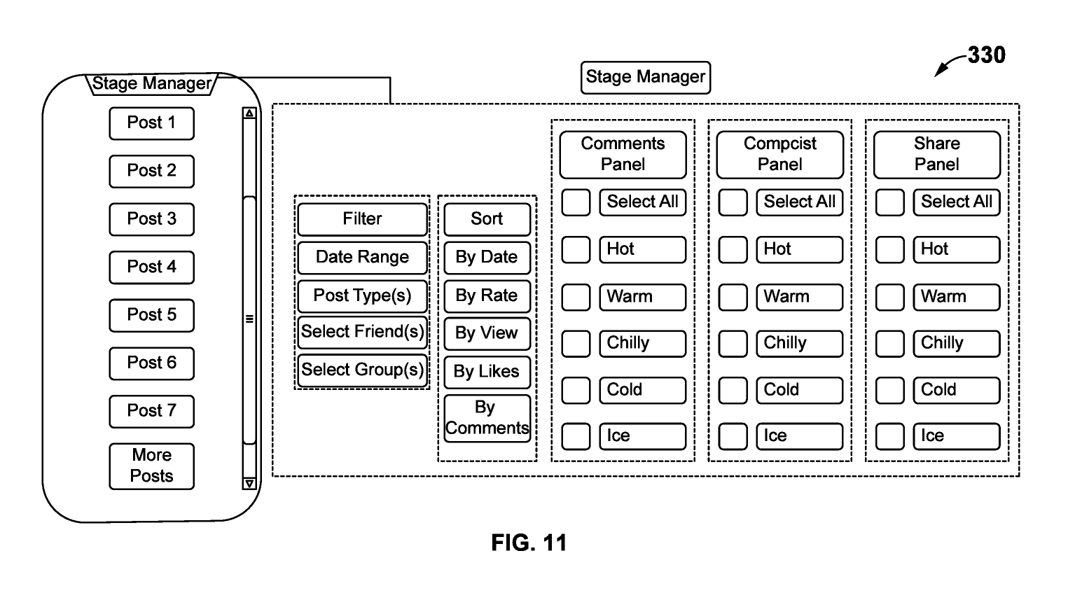

FIG. 11 exemplarily illustrates a screenshot 330 of managing posts of the user profile, according to one embodiment of the present invention. By default, all posts are sorted based on the time they have been sent or based on the setting defined on the stage manager or post manager. In some embodiment, the post could be sorted based on date range, post types, friends, groups, rating, views, likes or comments.

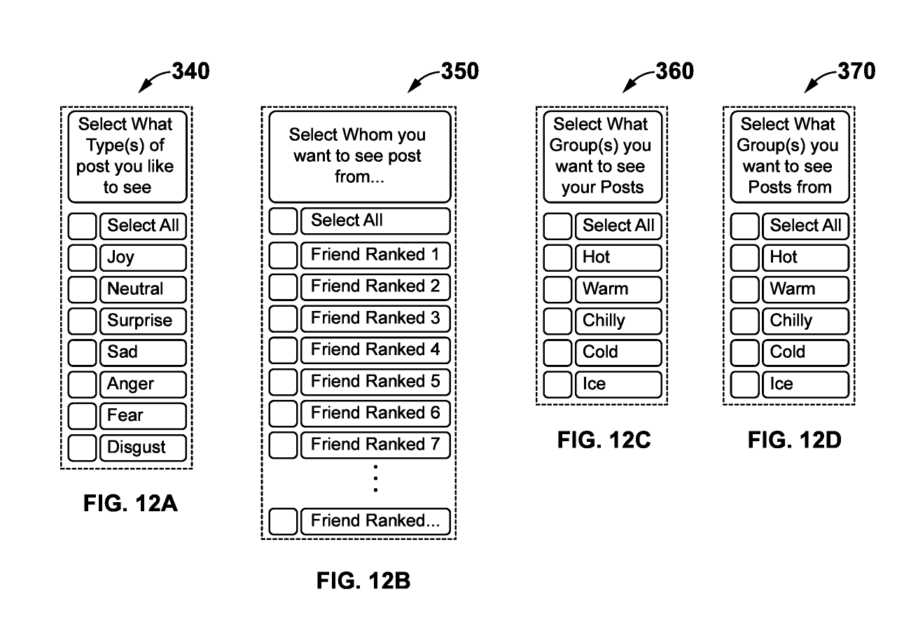

FIG. 12A exemplarily illustrates a screenshot 340 of filters to display preferred post, according to one embodiment of the present invention. In one embodiment, the filter include joy, neutral, surprise, sad, anger, fear and disgust.

FIG. 12B exemplarily illustrates a screenshot 350 of filter to display post from one or more specified friends, according to one embodiment of the present invention. In one embodiment, the filter include friend ranked 1, friend ranked 2, friend ranked 3, friend ranked “n th”.

FIG. 12C exemplarily illustrates a screenshot 360 of filter to allow the user to share post to a specified category of friends, according to one embodiment of the present invention. In one embodiment, the filter includes hot, warm, chilly, cold and ice.

FIG. 12D exemplarily illustrates a screenshot 370 of filters to receive of display post from one or more specified category of friends, according to one embodiment of the present invention. In one embodiment, the filter includes hot, warm, chilly, cold and ice.

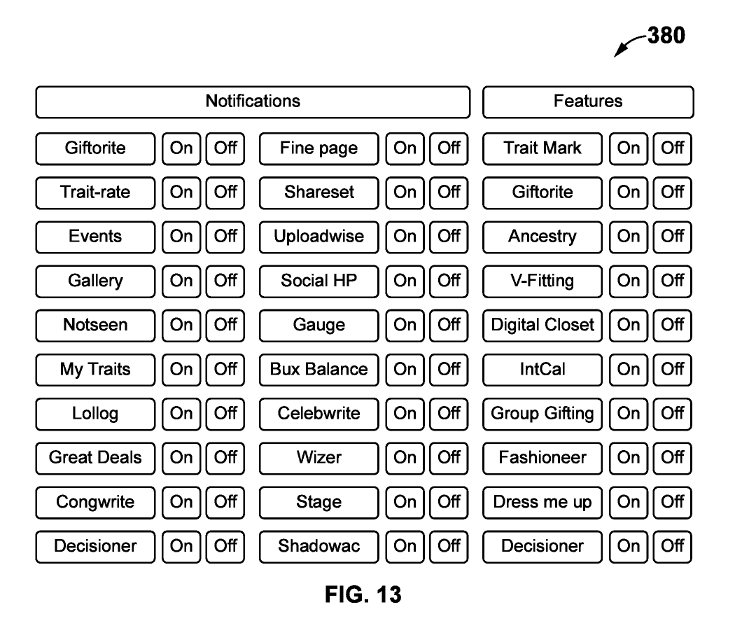

FIG. 13 exemplarily illustrates a screenshot 380 of customization various functions of the social network system via a single webpage, according to one embodiment of the present invention. The webpage displays all the functionality of the system, which could be easily turned ON/OFF based on user preference.

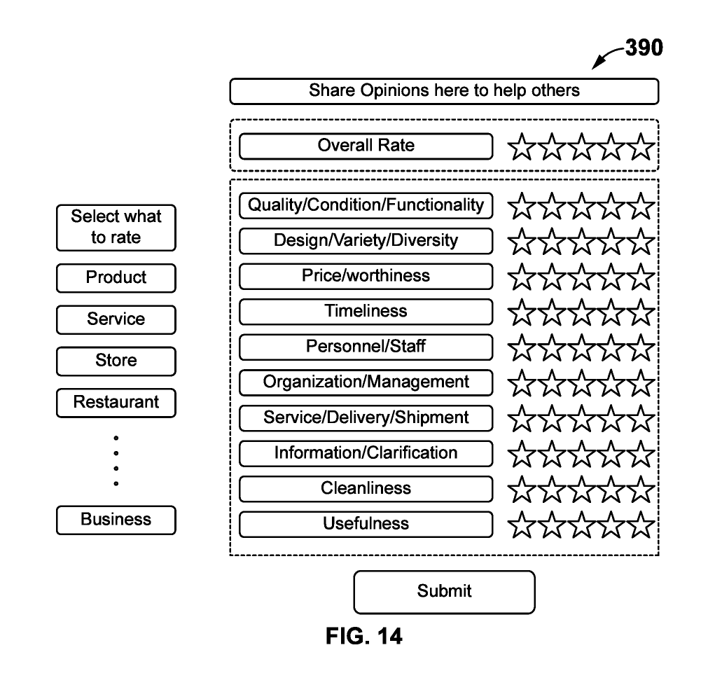

FIG. 14 exemplarily illustrates a screenshot 390 to rate a vendor service and products, according to one embodiment of the present invention. In one embodiment, the system displays various categories such as product, service, store, restaurant, business to provide rating. From the displayed categories, the user is enabled to select a desired category, where user is enabled to provide an overall rating or to provide various stages of services/delivery of products individually. The various stages comprise quality/condition/functionality, design/variety/diversity, price/worthiness, personnel/staff, timeliness, organization/management, service/delivery/shipment, information/clarification, cleanliness and usefulness.

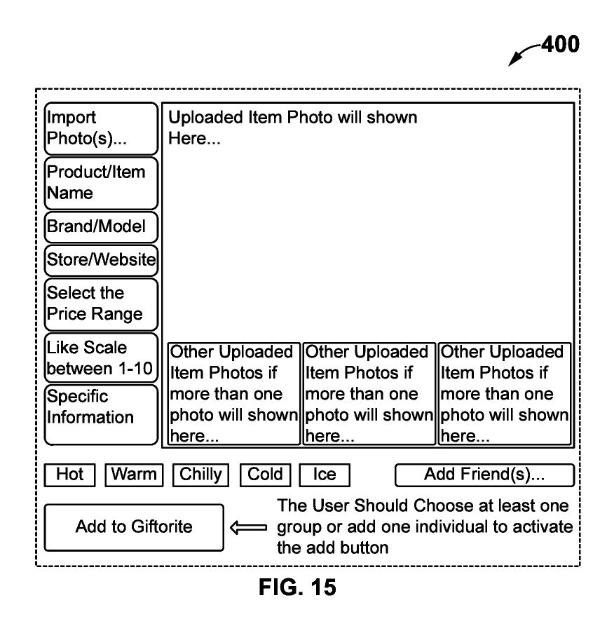

FIG. 15 exemplarily illustrates a screenshot 400 of adding one or more items to the gift list of the user, according to one embodiment of the present invention. The items are added to the list along with data such as product name, brand, model, store, website, price range, like scale and other specific information. After adding items, the user need to add at least one group of friends or a friend to submit the item to the gift list.

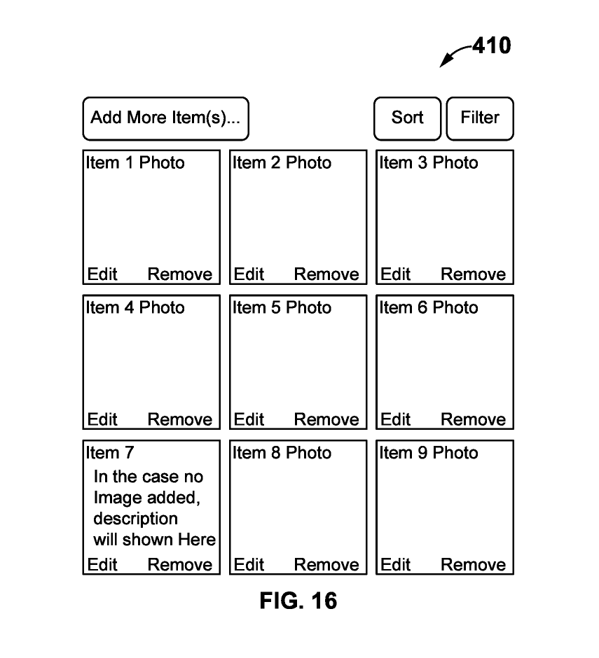

FIG. 16 exemplarily illustrates a screenshot 410 of gift list of the user, according to one embodiment of the present invention.

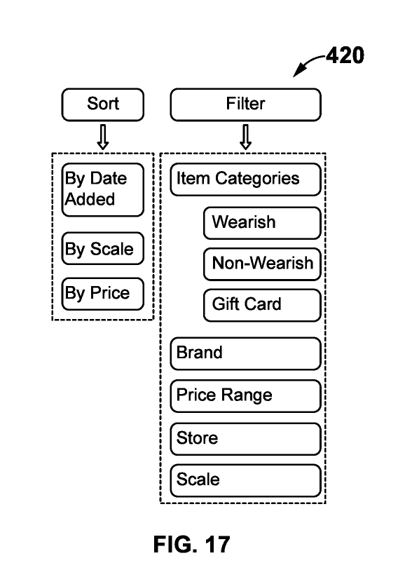

FIG. 17 exemplarily illustrates a screenshot 420 of filters and sort option to identify a gift to present from a friend's gift list, according to one embodiment of the present invention. The gift could be sorted by date, scale, price and filtered by item categories, brand, price range, store and scale.

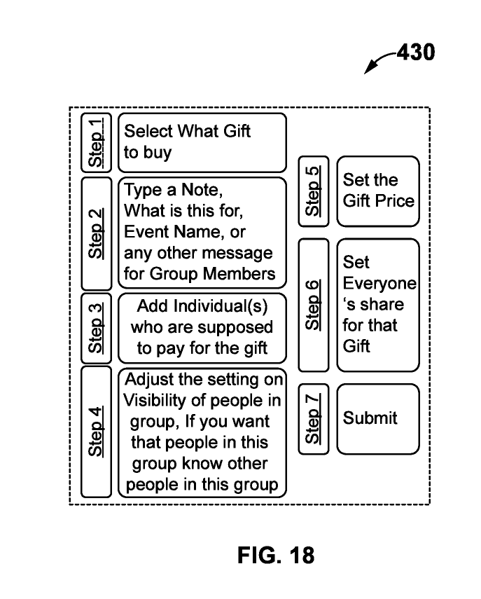

FIG. 18 exemplarily illustrates a screenshot 430 of creating a group to purchase a group gift, according to one embodiment of the present invention. Initially, the user need to select the gift to buy and need to type the event name or message for the group members. Then, the individuals, who need to pay for the gift are added to the group. Further, visibility settings could be adjusted if required. further, the price of the gift and everyone's share of the gift are set and submitted.

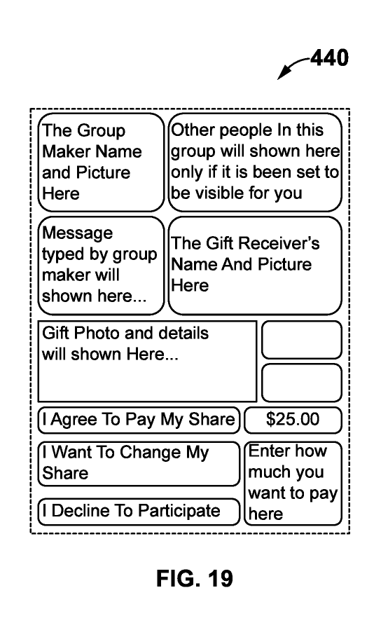

FIG. 19 exemplarily illustrates a screenshot 440 of request received to join group gifting process, according to one embodiment of the present invention. The request includes the group makers name, message from the group maker, gift receiver details, gift photo, price need to pay for the gift, options to change the share amount and options to decline the request.

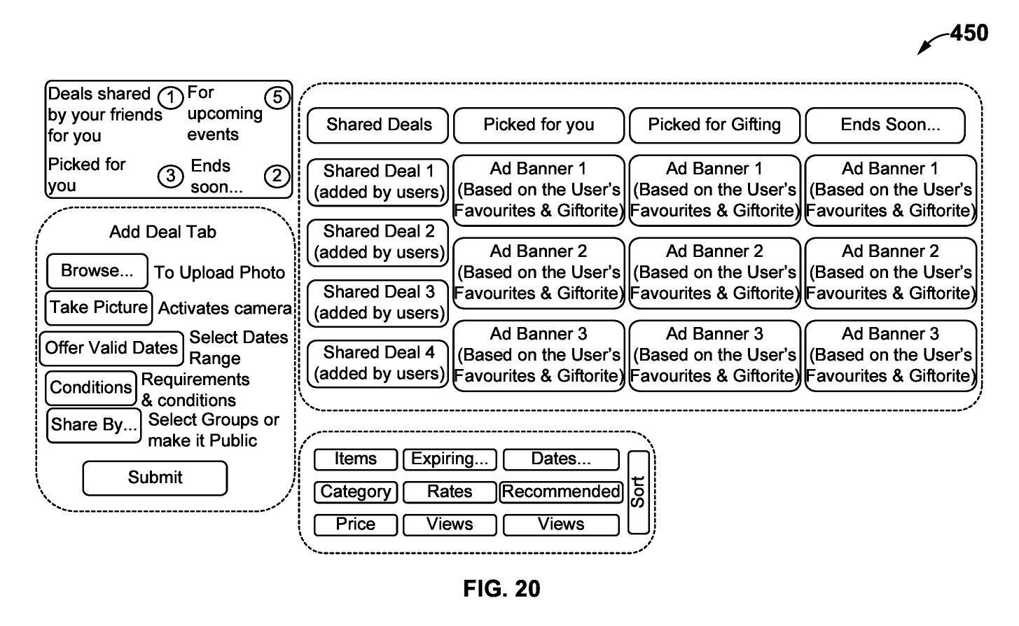

FIG. 20 exemplarily illustrates a screenshot 450 of a webpage to customize the advertisement displayed in the user profile, according to one embodiment of the present invention. The advertisement could be filtered and sorted by items, date, category, views, rating's, data, views, recommendation.

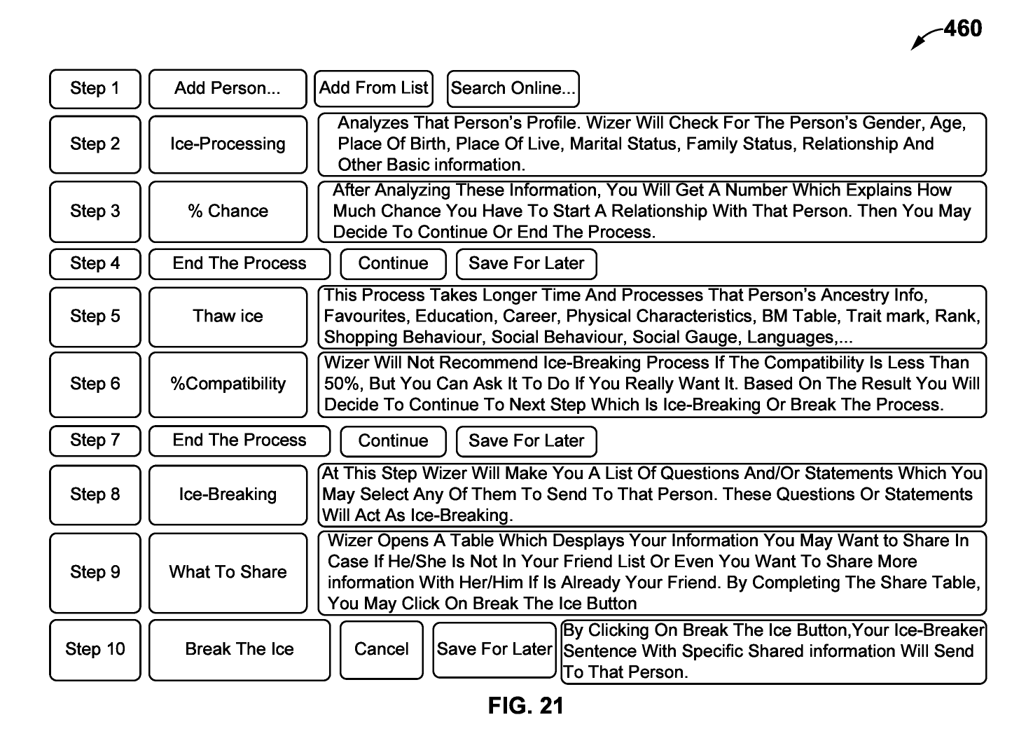

FIG. 21 exemplarily illustrates a screenshot 460 of process to identify compatibility of the user with other user to initiate conversation, according to one embodiment of the present invention. Initially, the system is configured to check all of the user's friends and friends of friends to see who is compatible with the user based on the user's situation, circumstances, personality, age, location, sex, education, career, ancestry, etc. Then, it makes a list of potential people. The system enables the user to add at least one potential person. Then, the system starts to analyze the profile of that person to check for the person's sex, age, education, career, physical characteristics, place of birth, place of live, marital status, family status, relationship and other basic information. After analyzing the information mentioned above, the user would receive a percentage number, which shows the chance percentage that the user has to start a relationship with that person. Based on the chance percent, the user may decide to continue the process to check the compatibility percent. The compatibility percent is identified by analyzing ancestry information, favorites, firstee, bestee, ttff, traitmark, ranks, shopping behavior, social behavior, social gauge, languages, giftorite, etc. If the compatibility percent, the system displays option to select or end the process.

If the user chose to continue the process, the system is configured to display a table which displays the user's information that the user may want to share with that person, in the case, if he/she is not in on the user's friend list or even if the user wants to share more information with her/him if that person is already the user's friend. Finally, the system displays a list of questions to start interaction with the other person. The relationship module further provides options to the user to decide one a time to send the message to that person, for example, the option could be to send the message when that person is online.

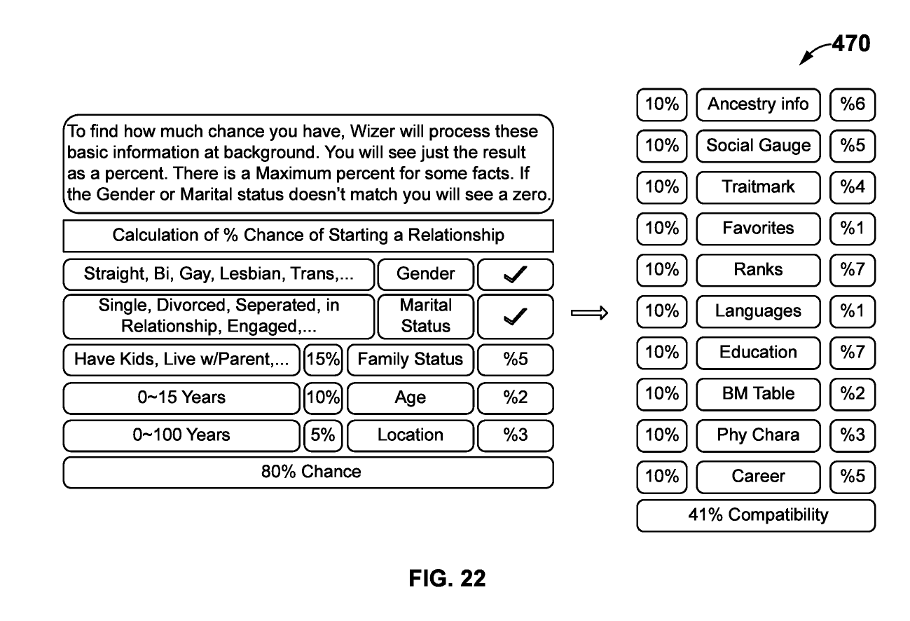

FIG. 22 exemplarily illustrates a screenshot 470 of percentage of chance and compatibility to start a relationship with a user, according to one embodiment of the present invention. To calculate the percentage of chance and compatibility, the system uses the basic information of the user. If the marital status or gender does not match with the zero, the score would be zero.

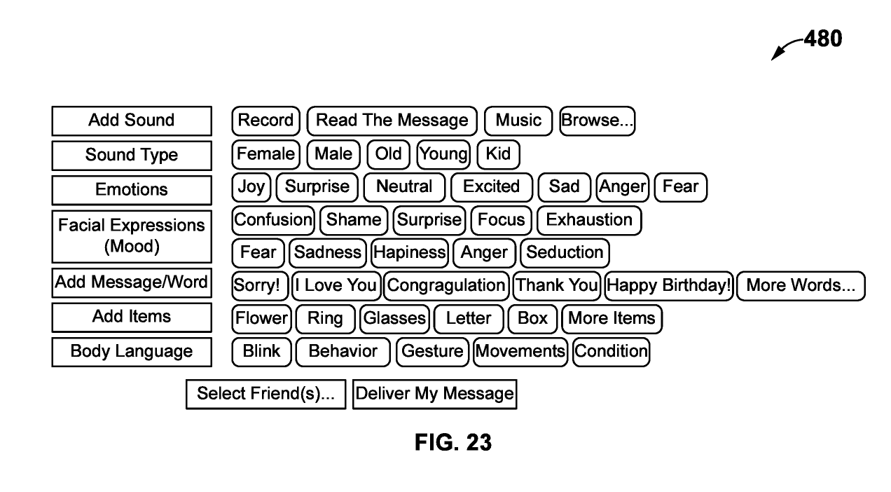

FIG. 23 exemplarily illustrates a screenshot 480 of customization of message to be delivered by a virtual character, according to one embodiment of the present invention. The message comprises background sound, voice effects, emotions, facial expressions, mood, add items, body language. In one embodiment, a music or sound file could be selected to play at background. In one embodiment, the voice effects include male, female, old, young or kid voices. In on embodiment, the emotions include joy, surprise, neutral, excited, sad, anger or fear. In one embodiment, the facial expressions/mood includes happiness, sadness, anger, fear, confusion, shame, surprise, focus, exhaustion, seduction, etc. In one embodiment, the items include flower, ring, heart, letter, gift box, envelope etc. In one embodiment, the body language function allows the user to adjust the body language of the virtual character such as body movements and gesture, blink, behavior, and conditions like respect, love, propose, request or even anger.

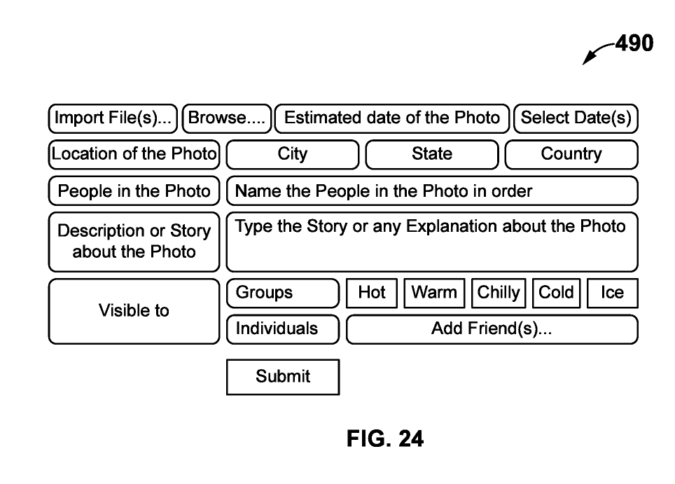

FIG. 24 exemplarily illustrates a screenshot 490 of posting activity data such as a story of vacation, according to one embodiment of the present invention. The system is configured to display options such as import files, location of the photo, people in the photo, description of photo, visibility settings to upload the activity data.

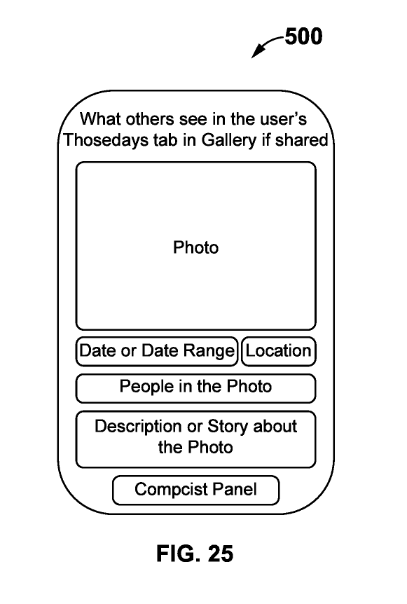

FIG. 25 exemplarily illustrates a screenshot 500 of shared activity data, according to one embodiment of the present invention.

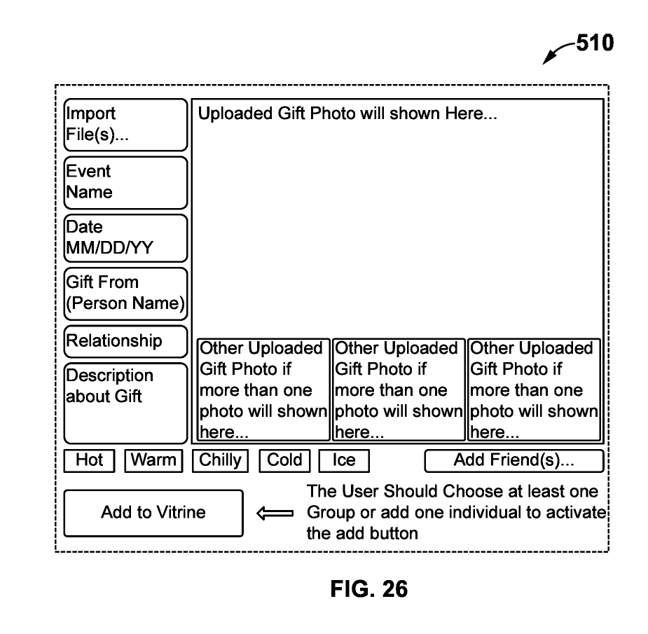

FIG. 26 exemplarily illustrates a screenshot 510 of uploading data of a desired gift to the gift list, according to one embodiment of the present invention. For uploading data, the fields such as event name, date, person from whom the gift received, relationship, description of the gift are provided. The user to fill respective details and choose at least one group of friends or at least one friend to upload the data.

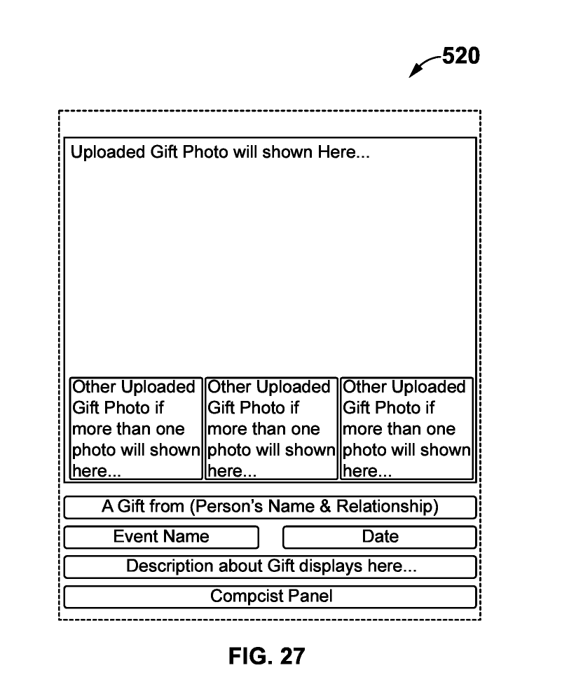

FIG. 27 exemplarily illustrates a screenshot 520 of gift data shared to other users, according to one embodiment of the present invention.

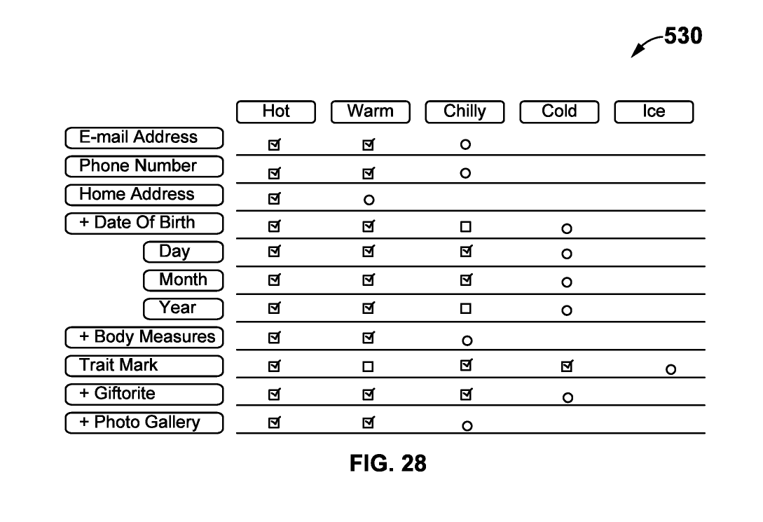

FIG. 28 exemplarily illustrates a screenshot 530 of customization of access to user information for one or more specified group of friends, according to one embodiment of the present invention.

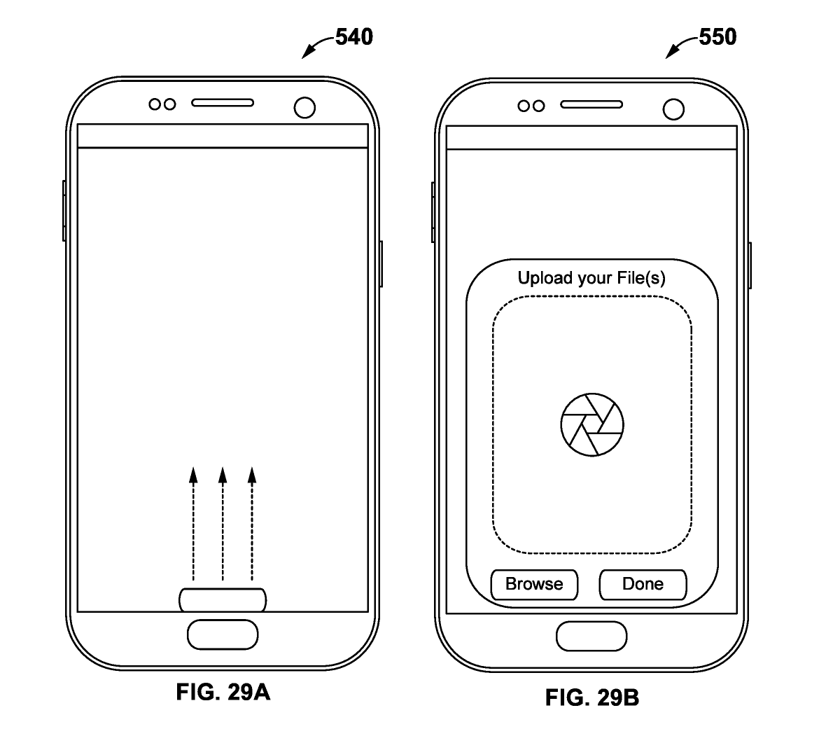

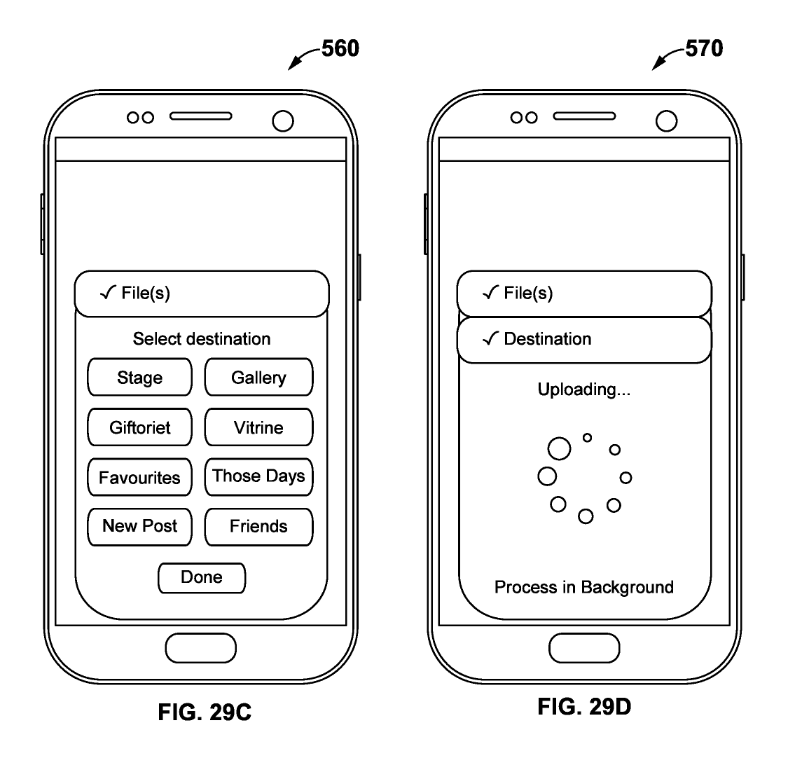

FIG. 29A-29D exemplarily illustrate screenshots (540, 550, 560 and 570) of uploading files into the user account and posting the uploaded files in the desired location such as gift list, gallery, according to one embodiment of the present invention. Instead of navigating to different pages and tabs, the user is enabled to first upload and then enabled to choose the location to submit the uploaded data.

Advantageously the present invention enables the user to focus on the gift and fashion market, organize and manage a user's social activities, provides entertaining features, helps users to earn money through their activity on the platform, decreases the level of depression, which is a drawback of current platforms, enables to customize display of advertisements while still permitting their benefits, helps users to focus more on themselves, helps users to know friends beyond reading their comments, enables to build stronger relationship between people, enables to solve problems related to buying/giving/receiving gifts, online self-shop, participating in events, dressing for a party, etc., reduces a user's stress in online activities and eliminates social pressure, helps users in online shopping based on centralized and categorized favorites, improving self-shop experience especially in the fashion area.

Preferred embodiments of this invention are described herein, including the best mode known to the inventors for carrying out the invention. It should be understood that the illustrated embodiments are exemplary only, and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A social network system for managing social life activities, comprising:
a social network server with artificial intelligence comprising a processor and a memory unit;
a database in communication with the server for storing plurality of user related information and information related to ecommerce platform, and
a user device configured to access the server via a network,
wherein the memory unit stores a set of program modules, and
wherein the processor in communication with the memory unit, configured to execute the set of program modules, wherein the set of program modules comprises,
a registration module configured to allow a user to create a user account by providing user information, wherein the user information comprises data to identify the user account, user private information and user public information,
a friend list management module configured to allow the user to group a list of friends in one or more categories, wherein each category comprises a particular level of access to the user information,
a body measurement module configured to allow the user to add measurement of body parts of the user, provide a 3D model of the user with 360-degree rotation, and enable the user to convert clothing size based on the brand and country of the retailer,
a gift module in communication with the body measurement module configured to allow the user to add one or more items to a gift list, allow the user to access the gift list of other users, allow the user to access the body parts measurement data of other users, allow the user to create a group comprising one or more friends to select one or more gift items to purchase the gift as a group, allow the user to connect with one or more retailer to purchase a desired gift from the gift list, allow the user to send notification to other users about the purchase of the gift, and enable the user to add gift data of received gifts in a received gift list, wherein the gift data includes brief description of the gift, event name, event date and location, and person who gave the gift.
a profile management module configured to allow the user to create encrypted address to share with other users, allow the user to share a post to one or more category of friends, allow the user to share the post to one or more category of friends with emoticon, allow the user to share the post to one or more category of friends anonymously, allow the user to select preferred type of advertisements, and display advertisements only on selection of advertisement tab
an entertainment module configured to enable the user to participate in an event to predict outcome of the event, wherein if the user predicted outcome is correct, a reward point is provided to the user,
a relationship management module configured to provide a virtual character with artificial intelligence, allow the user to deliver a message to the other user via the virtual character, and allow the user to check compatibility with the other user,
a rating module configured to allow the user to rate on one or more criteria of on purchase of the gift and allow a user to provide an overall rating on the purchase of the gift,
an assistance module configured to allow the user to assist other user in need of assistance, and acquire assistance from another user, and
social score module configured to measure a social power of the user.

2. The system of claim 1, wherein the registration module further configured to enable the user to create one or more account on behalf of another user.

3. The system of claim 1, wherein the registration module further configured to enable the user to create a guest account comprising user public information.

4. The system of claim 1, wherein at least one category enables the friends to access all information of the user account with exception to password details.

5. The system of claim 1, wherein at least one category enables the friends to access all information of the user account restricting personal or private information.

6. The system of claim 1, wherein at least one category enables the friends to access limited information specified by the user.

7. The system of claim 1, wherein the message is an animated message, a text message, voice message, a message with background sound, emoticons, body language or voice effects.

8. The system of claim 1, wherein the social power of the user is calculated based on number of contents shared by the user, number of messages sent by the user, number of messages received by the user, events made by the user, events participated by the user, gift provided by the user, gift received by the user, and category of the user on the friends list of another user.

9. The system of claim 1, wherein the profile management module further configured to:
enable the user to freeze the account to preventing user from accessing the account and allow other users to share content or send friend request,
enable the user to deactivate the account temporarily preventing other users to access the account,
allow the user to delete the account permanently,
enable the user to identify location of one or more user in the friend list,
enable the user to add event data,
enable the user to add data of activity experienced for the first time,
wherein the activity data comprises first car, first trip, first overseas travel,
enable the user to add an activity related data, wherein the activity data comprises buying an item, hired in a company, configured to enable the user to identify connection between a particular user and other users in the friends list of the user via a chart, and
enable the user to send appreciation to one or more user in the friends list.

10. The system of claim 1, wherein the profile management module further configured to enable the user to search for users by assigning filters including sex, age, location, favourites, ancestry, education, career, marital status, status,
enable the user to view his or her profile as a third-party user,
allow the user to delay the time to share content to by setting time delay,
enable the user to receive notification, wherein if any of his/her friends have been inactive for more than the chosen period, and
allow the user to upload files and move the uploaded file in desired section including gallery, share content.

11. A method for managing social life activities, incorporated in the system comprising a server with a processor and a memory unit, a database in communication with the server for storing plurality of user related information and information related to ecommerce platform, and a user device configured to access the server via a network, comprising:
allowing at the processor, via a registration module, a user to create a user account by providing user information, wherein the user information comprises data to identify the user account, user private information and user public information;
allowing at the processor, via a friend list management module, the user to group a list of friends in one or more categories, wherein each category comprises a particular level of access to the user information;
allowing at the processor, via a body measurement module, the user to add measurement of body parts of the user, to provide a 3D model of the user with 360-degree rotation, and enable the user to convert clothing size based on the brand and country of the retailer;
allowing at the processor, via a gift module in communication with the body measurement module, the user to add one or more items to a gift list, allow the user to access the gift list of other users, the user to access the body parts measurement data of other users, the user to create a group comprising one or more friends to select one or more gift items to purchase the gift as a group, the user to connect with one or more retailer to purchase a desired gift from the gift list, the user to send notification to other users about the purchase of the gift, and the user to add gift data of received gifts in a received gift list, wherein the gift data includes brief description of the gift, event name, event date and location, and person who gave the gift;
allowing at the processor, via a profile management module, the user to create encrypted address to share with other users, the user to share a post to one or more category of friends, the user to share the post to one or more category of friends with emoticon, the user to share the post to one or more category of friends anonymously, and the user to select preferred type of advertisements, and display advertisements only on selection of advertisement tab;
enabling at the processor, via an entertainment module, the user to participate in an event to predict outcome of the event, wherein if the user predicted outcome is correct, a reward point is provided to the user;
allowing at the processor, via a relationship management module, to enable a virtual character with artificial intelligence, the user to deliver a message to the other user via the virtual character, and the user to check compatibility with the other user;
allowing at the processor, via a rating module configured, the user to rate on one or more criteria of on purchase of the gift and allow a user to provide an overall rating on the purchase of the gift;
allowing at the processor, via an assistance module, the user to assist other user in need of assistance, and acquire assistance from another user; and
measuring at the processor, via social score module, a social power of the user.

12. The method of claim 11, wherein the registration module further configured to enable the user to create one or more account on behalf of another user.

13. The method of claim 11, wherein the registration module further configured to enable the user to create a guest account comprising user public information.

14. The method of claim 11, wherein at least one category enables the friends to access all information of the user account with exception to password details

15. The method of claim 11, wherein at least one category enables the friends to access all information of the user account restricting personal or private information

16. The method of claim 11, wherein at least one category enables the friends to access limited information specified by the user

17. The method of claim 11, wherein the message is an animated message, a text message, voice message, a message with background sound, emoticons, body language or voice effects.

18. The method of claim 11, wherein the social power of the user is calculated based on number of contents shared by the user, number of messages sent by the user, number of messages received by the user, events made by the user, events participated by the user, gift provided by the user, gift received by the user, and category of the user on the friends list of another user.

19. The method of claim 11, further comprising a step of: allowing at the processor, via the profile management module,
the user to freeze the account to preventing user from accessing the account and allow other the user to share content or send friend request,
the user to deactivate the account temporarily preventing other users to access the account,
the user to delete the account permanently,
the user to identify location of one or more user in the friend list,
the user to add event data,
the user to add data of activity experienced for the first time, wherein the activity data comprises first car, first trip, first overseas travel,
the user to add an activity related data, wherein the activity data comprises buying an item, hired in a company, configured to enable the user to identify connection between a particular user and other users in the friends list of the user via a chart, and
the user to send appreciation to one or more user in

20. The method of claim 11, further comprising a step of: allowing at the processor, via the profile management module,
the user to search for users by assigning filters including sex, age, location, favourites, ancestry, education, career, marital status, status,
the user to view his or her profile as a third-party user,
the user to delay the time to share content to by setting time delay,
the user to receive notification, wherein if any of his/her friends have been inactive for more than the chosen period, and
the user to upload files and move the uploaded file in desired section including gallery, share content.
